(19) United States
(12) Patent Application Publication
(10) Pub. No.: US 2011/0231476 A1
(43) Pub. Date: Sep. 22, 2011

(54) INFORMATION SERVICE PLATFORM EQUIPPED WITH DYNAMIC DISTRIBUTION OPERATORS

(76) Inventor: Tso-Sung HUNG, Hsinchu County (TW)

(21) Appl. No.: 12/729,092

(22) Filed: Mar. 22, 2010

(51) Int. Cl. G06F 15/16; G06F 15/173

(52) U.S. Cl. 709/203; 709/228

(57) ABSTRACT

An information service platform equipped with dynamic distribution operators aims to connect a plurality of clients with a plurality of servers to provide diversified service information to the clients. The invention mainly includes an asynchronous processing unit and a dynamic distribution unit. The asynchronous processing unit receives connection signals of the clients and processes the signals asynchronously to avoid link interruption caused by line crowded between the clients and servers. The dynamic distribution unit distributes the clients to the selected servers through the asynchronous processing unit in a dynamic distribution manner. Each server has a plurality of connection ports connectable with clients at the same time. The dynamic distribution unit dynamically distributes the clients to the idle connection ports.

### FIELD OF THE INVENTION

The present invention relates to an information service platform and particularly to an information service platform equipped with dynamic distribution function.

### BACKGROUND OF THE INVENTION

The society today is at an information explosion state. Most users generally download or search information through Internet. The commonly adopted data download service such as File Transfer Protocol (FTP in short) provides a link platform to connect users to a server to establish a connection and communication between them for the users to access files or data.

As every server has an Internet Protocol (IP). If the users want to link to different servers, a manual operation has to be performed to change the IP to link to different servers. It is a troublesome process. Moreover, FTP adopts synchronous transmission. In the event that too many users try to link to the server at the same time, line crowded could happen and result in link interruption. While many systems have provided resuming transmission service, reconnection of the link has to be done to redo transmission of the interrupted files. Such a link reconnection not only takes time, also tends to generate congested network when many users try to do reconnection at the same time. In addition, FTP cannot provide function other than file transmission, such as weather inquiry, real-time road condition information and disaster information and the like. Although users can search the aforesaid real-time information on the Internet, the information is dispersed and diversified, and difficult to get timely. At peak hours, the problem of network jam also easily occurs.

### SUMMARY OF THE INVENTION

The primary object of the present invention is to solve the problem of communication jam caused by a great amount of online connection.

Another object of the invention is to solve the problem of conventional manual operation of IP alteration for linking to different servers.

Yet another object of the invention is to solve the problem of link interruption of FTP caused by line crowded.

To achieve the foregoing objects, the present invention provides an information service platform equipped with dynamic distribution operators aiming to connect a plurality of clients. It includes a plurality of servers and a dynamic route system linked to the clients. The servers provide varying information service functions. The dynamic route system includes an asynchronous processing unit, a receiving unit connected to the asynchronous processing unit, a plurality of operator units connected to the receiving unit and a dynamic distribution unit connected to the operator units. The clients are linked to the receiving unit through the asynchronous processing unit. The asynchronous processing unit receives connection signals of the clients and processes the signals asynchronously to avoid link interruption caused by line crowded between the clients and servers. The operator units transfer the clients to the servers to be connected. The dynamic distribution unit distributes the clients processed by the operator units to the selected servers in a dynamic distribution manner.

By means of the structure set forth above, the asynchronous processing unit processes the signals asynchronously to avoid link interruption caused by line crowded between the clients and servers. The operator units can transfer the clients to the required servers. Thus a simple, fast and stable information search function can be provided. In addition, the dynamic distribution function provided by the dynamic distribution unit can reduce jammed condition caused by a great number of clients proceeding inquiry, access, upload and download to a same server at the same time.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of an embodiment of the invention.

FIG. 2 is a block diagram of an embodiment of the dynamic route system of the invention.

FIG. 3 is a flowchart of an embodiment of the invention.

### DETAILED DESCRIPTION OF THE PREFERRED EMBODIMENTS

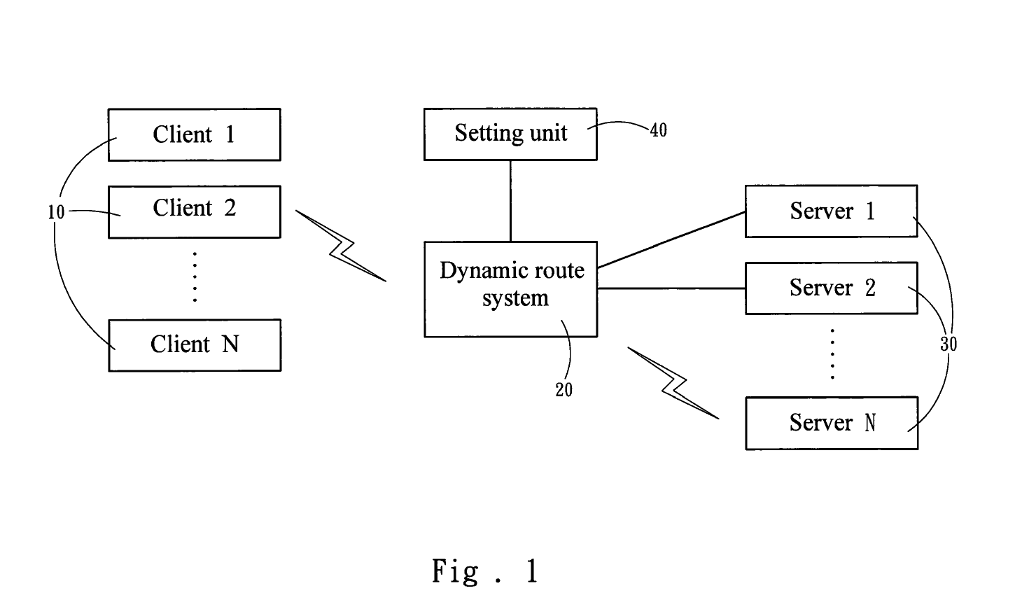

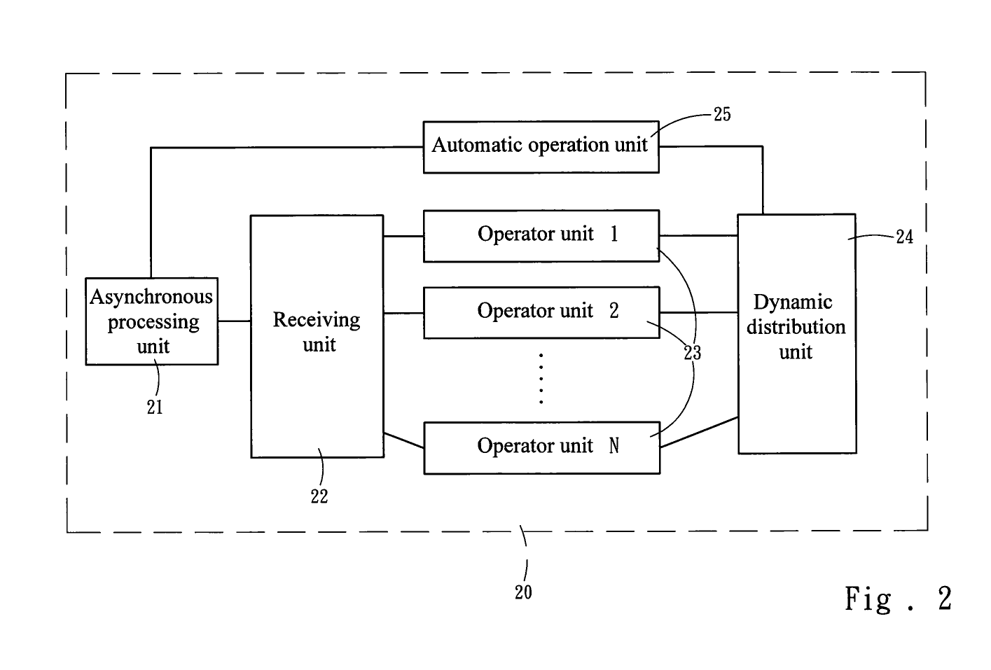

Please refer to FIGS. 1 and 2 for an embodiment of the invention. The invention provides an information service platform equipped with dynamic distribution operators aiming to connect a plurality of clients 10. The invention comprises a plurality of servers 30 and a dynamic route system 20 linked to the clients 10. The servers 30 provide varying information service functions, such as data download and upload services, weather inquiry service, traffic jam route inquiry service, earthquake information inquiry service, stock price inquiry service and the like.

The dynamic route system 20 includes an asynchronous processing unit 21, a receiving unit 22 connected to the asynchronous processing unit 21, a plurality of operator units 23 connected to the receiving unit 22 and a dynamic distribution unit 24 connected to the operator units 23. The clients 10 are linked to the receiving unit 22 through the asynchronous processing unit 21 via a connection approach of a group consisting of wired network, wireless network, telephone, wireless telephone, GPRS and satellite. The receiving unit 22 has a function can further confirm whether the clients 10 conform to selected linking rules, conformable rules include communication protocol, command format and required versions of the rules of the clients 10. In the event that the clients 10 do not conform to the rules, the connection is interrupted. In addition, in the event that the clients 10 are granted with priority connection, the granted one is processed at a higher priority. The asynchronous processing unit 21 receives connection signals from the clients 10 and processes the signals asynchronously to avoid link interruption caused by line crowded between the clients 10 and servers 30. The operator units 23 transfer the clients 10 to the servers 30 to be connected. It is to be noted that the operator units 23 have question-and-answer function to automatically ask required functions by the clients 10, and upon receiving the answers from the clients 10, the operator units 23 further ask more detailed content or transfer to the dynamic distribution unit 24 to do further processing. Moreover, the operator units 23 also have to confirm whether the answered content complying with the rules of the servers 30 and existence of the servers 30 selected by the clients 10. If the outcome is negative, the service is denied. The dynamic distribution unit 24 distributes the clients 10 processed by the operator units 23 to the selected servers 30 in a dynamic distribution manner. Furthermore, the servers 30 usually have mating connection ports connected to different clients 10 at the same time. The dynamic distribution manner means to make priority selection of idle connection ports for linking to the clients 10 without wasting the connection ports to improve usability thereof.

The dynamic route system 20 also includes an automatic operation unit 25 to allow the clients 10 to form automatic connection with the servers 30 and transmission of relative information. For instance, the clients 10 can be set to download earthquake statistical data, stock price information and weather forecast information in a scheduled mode or real-time mode. Then after the clients 10 are linked to the information service platform of the invention, the aforesaid statistical data and information will be automatically downloaded as set to provide users a simpler and faster use environment.

The dynamic route system 20 further is connected to a setting unit 40 to set parameters in the dynamic route system 20, including Internet connection setting (such as IP and domain name), setting connection ports of the operator units 23, setting the number of the operator units 23, setting the connection ports of the servers 30, setting the number of the servers 30, designating version number, account number and passwords which the clients 10 conform with the rules of the servers 30, editing the question-and-answer process, setting answering speed and the like.

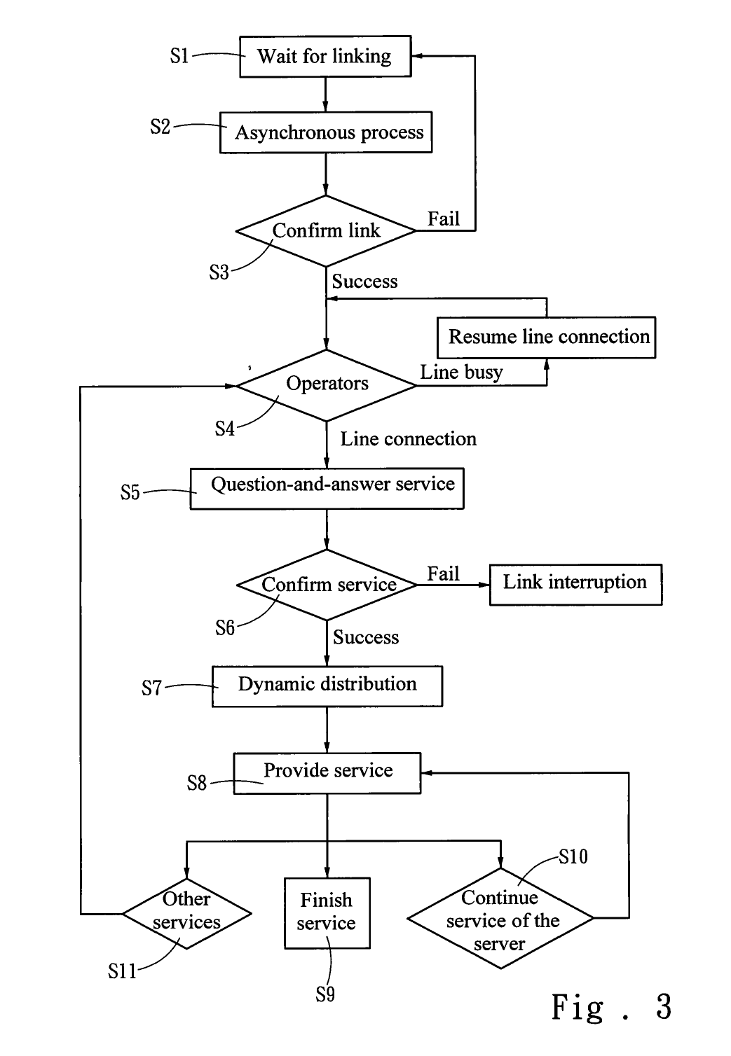

Refer to FIG. 3, also FIGS. 1 and 2 for the flowchart of an embodiment of the invention. The invention can be implemented through steps S1 to S11 as follow: S1: waiting for linking, the setting unit 40 sets parameters for the dynamic route system 20 and maintains the line in the connection state for waiting for the linking of the clients 10; S2: the asynchronous processing unit 21 processing signals asynchronously from the clients 10 to avoid link interruption caused by line crowded between the clients 10 and servers 30; S3: confirming the link, when the link between the clients 10 is established through the asynchronous processing unit 21 and receiving unit 22, the receiving unit 22 confirms the link of the clients 10 is established first and further confirms the link is conformed to the rules; interrupting the link and waiting for linking anew if the link to the clients 10 is failed or the rules are not complied; S4: establishing connection between the clients 10 and operator units 23 through asynchronous processing; in the event that all the operator units 23 are busy, resume linking process until connection to the operator units 23 is established; S5: question-and answer services; confirming service content through inquiries of the operator units 23 and answers of the linked clients 10; S6: confirming services; transmitting the connection signals of the clients 10 to the dynamic distribution unit 24 if the service request conforms to the rules and connection between the desired servers 30 and the clients 10 is established; interrupting the connection if the service does not conform to the rules; S7: dynamic distribution; dynamically distributing the clients 10 to the connection ports of the servers 30, after the dynamic distribution unit 24 confirms the connection between the desired servers 30 and the clients 10. establishing connection between the clients 10 and the connection ports of the servers 30 in the dynamic distribution manner; S8: providing services; the servers 30 provide services to the connected clients 10; S9: finishing services; after requested services of the clients 10 are finished, ending line connection; S10: continuing services of the servers 30; aside from directly selecting to end the line connection, it also can select not to end the line connection and continue to provide other service items for the same server 30; S11: providing other services; aside from going to steps S8 and S9, it also can select to jump to step S4 to resume line connection with the operator units 23, and proceed question-and-answer services from the operator units 23 to understand requested service content.

As a conclusion, the invention provides the asynchronous processing unit 21 to process signals asynchronously to prevent link interruption caused by line crowded between the clients 10 and servers 30. Through the operator units 23, the clients 10 are transferred to desired servers 30. It provides a simple and convenient information search function. Moreover, through the dynamic distribution function provided by the dynamic distribution unit 24, line jammed condition caused by a great number of search and access from the clients 10 to an identical server 30 at the same time can be reduced. In addition, the automatic operation unit 25 automatically performs data search, download and upload for requested items in the scheduled or real-time mode, thus offers a simpler and more convenient operation environment for the clients 10.

In summation of the above description, the present invention provides a significant improvement over the conventional techniques and complies with the patent application requirements, and is submitted for review and granting of the commensurate patent rights.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An information service platform equipped with dynamic distribution operators to provide connection and service information for a plurality of clients, comprising:
a plurality of servers equipped with varying information service functions; and
a dynamic route system which is connected to the clients and includes an asynchronous processing unit, a receiving unit connected to the asynchronous processing unit, a plurality of operator units connected to the receiving unit and a dynamic distribution unit connected to the operator units; the clients being connected to the receiving unit through the asynchronous processing unit; the asynchronous processing unit receiving connection signals of the clients and processing the signals asynchronously to avoid link interruption caused by line crowded between the clients and servers; the operator units being equipped with automatic question-and-answer function and transferring the clients to the servers to be connected after finishing the question-and-answer process with the clients; the dynamic distribution unit distributing the clients processed by the operator units to the selected servers in a dynamic distribution manner.

2. The information service platform of claim 1, wherein the receiving unit further is equipped with function of confirming whether the connection with the clients conforms to selected rules.

3. The information service platform of claim 1, wherein the operator units further are equipped function of confirming whether requests of the clients conform to rules of services.

4. The information service platform of claim 1, wherein the receiving unit further is equipped with a priority mechanism to provide prioritized clients a higher priority of access.

5. The information service platform of claim 1, wherein the dynamic route system further is connected to a setting unit to set parameters in the dynamic route system.

6. The information service platform of claim 1, wherein the clients are selected from the group consisting of wired network and wireless network to form the connection with the receiving unit through the asynchronous processing unit.

7. The information service platform of claim 1, wherein the clients are selected from the group consisting of wired telephone, wireless telephone, GPRS and satellite to form the connection with the receiving unit through the asynchronous processing unit.

8. The information service platform of claim 1, wherein the receiving unit is connected to an automatic operation unit to provide automatic connection and transmit information between the clients and the set servers.
